(19) United States
(12) Patent Application Publication
(10) Pub. No.: US 2007/0070231 A1
(43) Pub. Date: Mar. 29, 2007

(54) Radiation monitoring apparatus and method

(75) Inventors: William Roland Hawes, Hertfordshire (GB); Martin Philip Gouch, Hertfordshire (GB)

Correspondence Address: SUGHRUE MION, PLLC, 2100 PENNSYLVANIA AVENUE, N.W., SUITE 800, WASHINGTON, DC, 20037, US

(73) Assignee: FUJIFILM ELECTRONIC IMAGING LTD.

(21) Appl. No.: 11/233,139

(22) Filed: Sep. 23, 2005

(51) Int. Cl. H04N 5/335; H04N 3/14

(52) U.S. Cl. 348/311

(57) ABSTRACT

A method of operating a radiation monitoring device is provided. The device has a plurality of photo-sites upon which when in use, electrical charges accumulate in response to received radiation, and a transport register comprising a plurality of register locations adapted to receive the accumulated charges from the photo-sites. Electrical charges are extracted from target register locations corresponding to target photo-sites at a first clock frequency from non-target register locations corresponding to non-target photo-sites at a second clock frequency. The second clock frequency is higher than the first clock frequency. Apparatus for performing the method is also provided.

The present invention relates to a radiation monitoring apparatus and a method of using such apparatus.

Various devices for monitoring the intensity and/or frequency of electromagnetic radiation are well known. One example is the use of a charge coupled device (CCD) which typically comprises an array of photo-sensors, the device being arranged in use such that incident radiation causes electrical charging of the photo-sensor sites. Following the accumulation of the electrical charge on the respective photo-sites, this charge is then transferred to a transport register thereby freeing up the photo-sites for the accumulation of further charge in response to further incident radiation. The transfer of the charge from the photo-sites to the transport register is typically a high speed parallel process in which the transfer occurs from the numerous sites to corresponding locations in the transport register substantially simultaneously. Once within the transport register, the charge from each of the transport register locations is extracted in a serial manner to an output charge amplifier and digitiser. This therefore converts the amount of charge received by the various photo-sites into digital data. The serial extraction is known as “read-out” or “clocking” of the transport register.

A transport register is typically clocked from one end such that all of the charges within the respective locations are shifted towards the read-out end of the register during the clocking process. However, if the parallel transfer of the next set of charges from the photo-sites is performed before the charges for the previous line have been clocked out in their entirety, then the newly transferred charges from the photo-sites are added to those already remaining within the transport register for the previous line. In order to avoid this, the CCD “line time” is set to be a minimum of the clock frequency at which the CCD is serially clocked, multiplied by the number of register locations.

One problem with this approach is that the time taken to clock all of the locations of the CCD transport register is rate-limited by the clock frequency of the CCD multiplied by the number of locations. In many cases, there is only interest in the accurate read-out of a fraction of the photo-sites in the CCD device and yet even if this is the case, it is necessary to wait for all of the register locations to be clocked out upon every detected line.

One way to address this problem is to mask the areas of the CCD photo-sensors that are not being used. This means that it is not necessary to read out the entire array of photo-sites for each line. Provided that there are as many “masked photo-site” register locations in the register following those corresponding to the photo-sites of interest, then the masked locations can be used for the photo-sites of interest for the next line. This provides a speed advantage since two lines worth of data can be read from a single register line. One problem with this is that it is difficult to fully mask parts of the CCD due to internal reflections within the device. Whilst a mask can prevent the charge generated in the photo-sites due to incident radiation exposure from an external source, it cannot fully prevent the presence of a “dark signal” from internal reflections and so on. This means that register locations which are loaded from the masked area and then loaded with charge relating to a desired (un-masked) photo-site, will contain twice as much dark charge. The dark signal limits the dynamic range of the CCD device. One further problem of masking is that where the CCD is being used during different operations, often the masked area will have to be moved in association with this. This causes downtime of the CCD.

There is therefore a need to overcome the problems of using a CCD or similar device where only some of the photo-sites are required to be monitored for radiation received by those sites.

In accordance with a first aspect of the present invention, we provide a method of operating a radiation monitoring device, the device having a plurality of photo-sites upon which when in use, electrical charges accumulate in response to received radiation, and a transport register comprising a plurality of register locations adapted to receive the accumulated charges from the photo-sites, the method comprising:—

extracting the electrical charges from target register locations corresponding to target photo-sites at a first clock frequency; and

extracting the electrical charges from non-target register locations corresponding to non-target photo-sites at a second clock frequency, the second clock frequency being higher than the first clock frequency.

In addressing this problem, we have adopted a new approach in that we have realised that whilst register locations corresponding to photo-sites of interest can be read out at a conventional (first) clock frequency, any charge within register locations corresponding to photo-sites which are not of interest can be read out at a higher clock frequency (second clock frequency).

In the present invention therefore, it is desired to monitor the radiation received by a number of photo-sites, this number being smaller than the total number of photo-sites with which the device is equipped. The photo-sites from which it is desired to obtain monitored information regarding the radiation received, are referred to herein as “target photo-sites”. Conversely, the photo-sites from which it is not desired to obtain monitored radiation information, are referred to as “non-target photo-sites”. Typically such non-target photo-sites are those which in the prior art would be masked.

The present invention provides a number of advantages over the prior art methods, for example in that it removes the dark charge problems caused by masking. Furthermore, since the process can be effected by electronic or software means, the sites which constitute target photo-sites can be selected virtually instantaneously without any physical modification of the device. In the case of a masked CCD, for example, it would be necessary to fit a new mask or move the current mask if different photo-sites were needed for use as target photo-sites.

Typically the photo-sites comprise individual photo-sensors arranged in an array, such as a one-dimensional (linear) array. Preferably a transport register having a corresponding number of locations is provided, such that the number of locations is equal to the number of photo-sites. However, a correspondence between such sites and locations which is not a one-to-one correspondence is also envisaged (for example many photo-sites relating to each location). Note that the invention can be used with any suitable radiation and corresponding detector. The term photo-sites is intended to include sites which are capable of detecting non-photonic radiation and therefore the term includes detectors capable of detecting electromagnetic radiation of any kind, and detectors for non-electromagnetic radiation.

Preferably therefore, the charges are extracted from the register locations by a read-out process. Typically this is in a serial manner and the extraction may occur from one end of the transport register by shifting the charges between adjacent register locations so as to extract the charge from each of the register locations in turn.

Typically the non-target photo-sites are arranged at one or each end of the total set of photo-sites of the device with the target set constituting the remaining photo-sites. It is envisaged that two or more sets of target photo-sites may be positioned within the total set of sites of the device array, these being separated by non-target sites. Target photo-sites may also be positioned in a further alternative at either end of the device, separated by non-target photo-sites.

Preferably when any non-target register locations are extracted before any remaining target locations, the said non-target locations are extracted at a second clock frequency which is adapted to ensure that substantially all of the charges are transferred between adjacent locations. The second clock frequency is therefore controlled such that the charges relating to the target photo-sites are reliably read out from the register. When the last target photo-site has been read out, a higher second clock frequency may be used since it is not necessary to efficiently transfer the charge from the remaining register locations. More than one frequency can therefore be used as the second clock frequency.

Although a second clock frequency of much greater than 50 MHz can be used, typically the second clock frequency is less than 50 MHz and more preferably, the second clock frequency is substantially 44 MHz. The first clock frequency is preferably less than 25 MHz and more preferably the first clock frequency is substantially 22 MHz.

In some devices the register may actually comprise two or more sub-registers. For example one sub-register being related to “odd” numbered photo-sites, the other being related to “even” numbered photo-sites. In each case, the sub-register may be thought of as an independent transport register for the purposes of the invention.

The invention also extends to a computer program product comprising program code means adapted to perform the method according to the first aspect of the invention. The invention is also intended to include the embodiment of such a computer program product upon a computer-readable medium.

In accordance with a second aspect of the present invention, we provide radiation monitoring apparatus comprising a radiation monitoring device, the device having a plurality of photo-sites upon which, why in use, electrical charges accumulate in response to received radiation, and a transport register comprising a plurality of register locations adapted to receive the accumulated charges from the photo-sites, the system further comprising a controller adapted to perform the steps of:—

extracting the electrical charges from target register locations corresponding to target photo-sites at a first clock frequency; and

extracting the electrical charges from non-target register locations corresponding to non-target photo-sites at a second first clock frequency, the second clock frequency being higher than the first clock frequency.

The controller of such apparatus may therefore be adapted to perform the method according to the first aspect of the invention. The controller may take the form of a microprocessor operated with appropriate software, or indeed other forms, such as programmable logic. Typically the photo-sites are arranged in an array such as a linear array. As before, the register may comprise two or more sub-registers adapted such that the electrical charges are extracted from the sub-registers independently. The digital data from each may then be combined by a downstream processor. The radiation monitoring device of the first or second aspects of the invention may take the form of a number of different types of device, these including a charge coupled device (CCD), CMOS image sensor (CIS), and a time domain integrator (TDI).

The invention is not limited to any particular type of electromagnetic radiation although it is envisaged that one or more of ultra-violet light, visible light of infra-red light may typically constitute the radiation detected.

An example of a method of operating a radiation monitoring device according to the invention will now be described with reference to the accompanying drawings, in which:—

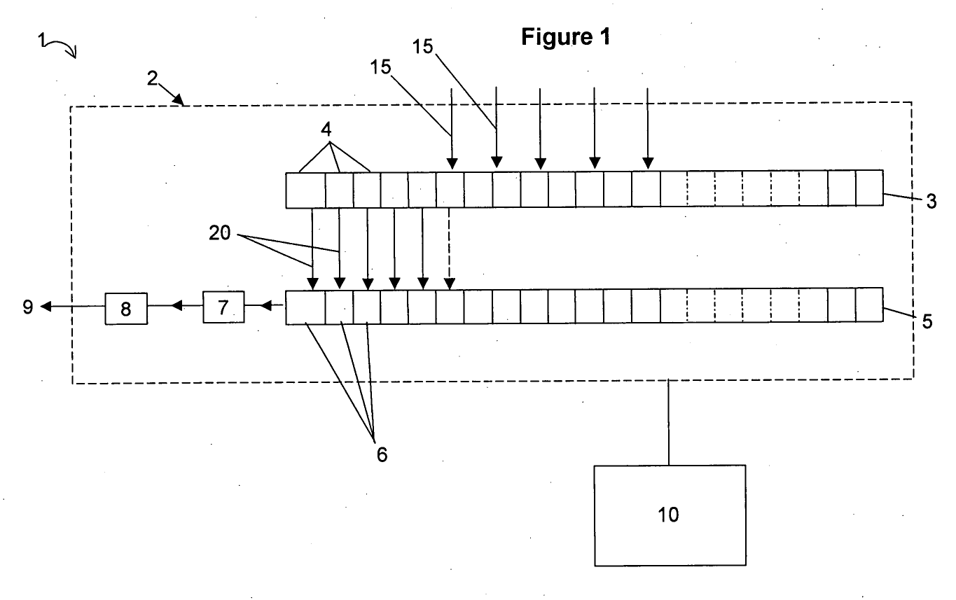

FIG. 1 shows apparatus according to a first example;

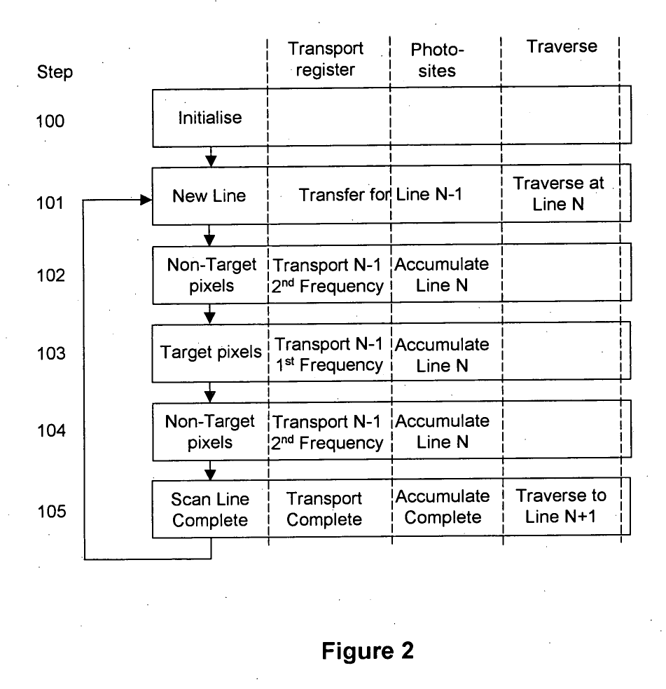

FIG. 2 is a flow diagram of a first example method; and,

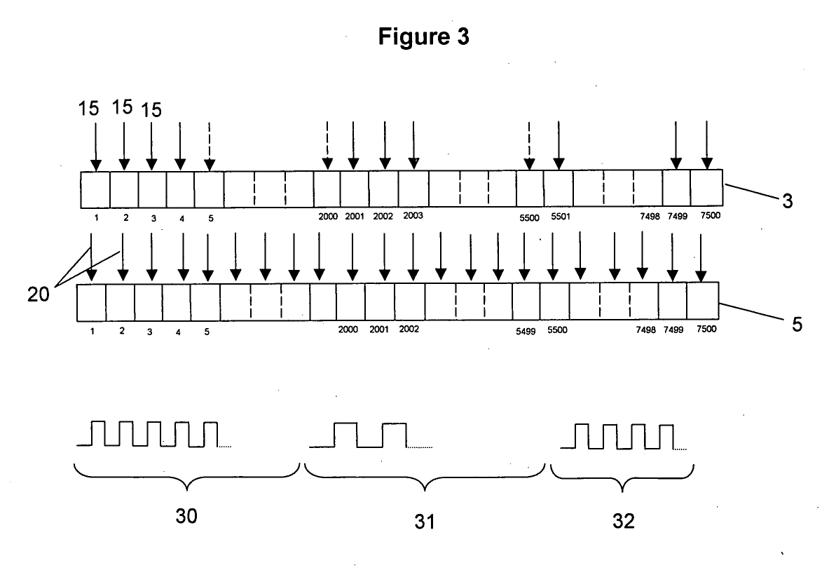

FIG. 3 shows the clocking of a device register in accordance with the invention.

An example of apparatus according to the invention is shown schematically in FIG. 1. A radiation detecting apparatus is generally indicated at 1, this comprising a charge coupled device (CCD) 2. The CCD 2 comprises a linear array of photo-sensors 3, each of the sensors comprising photo-sites 4. Typically a CCD array 3 may comprise a number of thousand photo-sites 4. The CCD 2 also comprises a transport register 5 having a number of register locations 6. In this case there is a one-to-one correspondence between the number of register locations 6 and the photo-sites 4. The CCD 2 also is provided with a charge amplifier 7 for receiving the charges from the register locations 6. The charge amplifier 7 is also coupled to a digitiser 8 for digitising output analogue signals received from the charge amplifier. The apparatus 1 also comprises a controller 10 which in the present case takes the form of programmable logic, this being coupled to the CCD 2 so as to operate the CCD. The controller 10 may form part of the CCD 2 itself. Other controllers such as microprocessor-based controllers which operate in response to software, are also envisaged.

The radiation detecting apparatus 1 of this example forms part of a scanner device in which the CCD is mechanically scanned along a scan path thereby building up image data by the repeated read-out of the CCD during the scan in a known manner.

Referring now to FIG. 2 a method of operating the apparatus in accordance with the invention is now described in terms of steps 100 to 105. FIG. 2 illustrates the progress of the method from the point of view of the transport register, the photo-sites and the traverse mechanism of the scanner, each of these being denoted by corresponding columns to show how the processes are performed in parallel.

At step 100 the apparatus is initialised. At step 101, the CCD 2 is positioned so as to begin the scan of a new line “N” (see the traverse column) at a predetermined location in the scan path. At the same time the charge from the photo-sites 4 for the previous scan line (N−1) is transferred in parallel to the transport register. As will be understood, for a first line of the desired scan this charge is not from a valid area of the image. However, since this is a process comprising repeated steps, the description below is for the general case where the previous scan line “N−1” does contain image information of interest.

At step 102, exposure of the CCD begins by the receipt of light radiation from a scanner light source, this being modulated by an object being scanned. This impinging light is illustrated in FIG. 1 by the arrows 15.

FIG. 3 shows the receipt of the light in more detail. The linear array 3 in the present example contains 7500 individual photo-sites in the form of photo-sensors. Some of these are illustrated by numbers 1 to 7500 in FIG. 3. The impinging light of varying intensity is received by all of the photo-sites, although in the present example, only the light received by photo-sites 2001 to 5500 are of interest to the user for the scan line N (and indeed for subsequent scan lines N as the steps of the method are repeated).

In the present example the photo-sites 2001 to 5500 comprise “target” photo-sites, with sites 1 to 2000 and 5501 to 7500 being “non-target” photo-sites. The target photo-sites are therefore found in the central part of the full linear array 3 width. One reason for the sites 2001-5500 being of interest to a user of the scanner is that it is known that a target medium being scanned is only present physically in the position occupied by this range of sites.

Returning now to the flow diagram of FIG. 2, the exposure of the first line N (1×7500 photo-sites) occurs for a pre-determined duration, as it known in the art. During this step, electrical charge is accumulated upon each of the photo-sites in accordance with the intensity of the light received and under the control of controller 10. In this example the accumulation actually occurs over three steps (102 to 104).

During a first part of this exposure period represented by step 102, the transport register locations for the non-target photo-sites of the previous line N−1 are read out from the transport register at a predetermined frequency.

The read-out process begins by the extraction of the charge from location number 1, this charge being passed to the charge amplifier 7 for amplification and then, subsequently, digitisation by the digitiser 8. The output of the digitiser (shown at 9 in FIG. 1) is then passed to a downstream processing device such as a computer. Having read out the charge from register location 1, each of the charges in the remaining locations 2 to 7500 are all transferred along the register to fill the locations 1 to 7499. The new charge in location 1 (formerly 2) is then read out and again each of the remaining charges in the remaining locations are transferred one location along the register. For step 102 this process is repeated until the charge initially within the register location 2000 is present within the location 1 and this is finally read out to complete step 102. The speed of the above process is controlled by the controller 10.

In detail, the controller 10 operates the read-out process by issuing signals having a predetermined clock frequency. In this example it will be recalled that the charges within photo-sites 1 to 2000 are non-target sites and therefore not deemed to be of interest. As a result, for these sites, the controller sets the clock frequency to a “second clock frequency” which in this case is 44 MHz thereby reading out the first 2000 register locations at this frequency. The time required to perform this is 2000/44×10⁶=0.0455 ms. It should be noted that 44 MHz is the maximum operational clock frequency of the present CCD device 2. The non-target register locations 1 to 2000 are therefore read out comparatively quickly at step 102.

Whilst the accumulation of charge on the photo-sites continues, during step 103 the target register locations (that is, those of interest) are read out from the transport register 5. In this case the register locations 2001 to 5500 relate to “target” photo-sites for which it is desired to know accurately the amount of radiation received. A lower clock frequency (first clock frequency) is therefore used at step 103 for reading out these target photo-sites. The frequency chosen in this case is 22 MHz which is a suitable read-out frequency so as to obtain high quality output data. The duration of this is 0.159 ms.

During a subsequent step 104, and whilst the accumulation of charge for the line N continues upon the photo-sites, the remaining register locations 5501 to 7500 are read out, again at the maximum frequency, that is, the second clock frequency. The duration of this step is again 0.0455 ms. The charge accumulation is completed by the end of step 104.

The variation in the clock frequency for the target and non-target locations is illustrated at 30,32 (non-target) and 31 (target) in FIG. 3.

Following the completed read-out of the charge from the transport register during steps 102 to 104, at step 105 the accumulation of charge for line N is complete and the scanner traverse mechanism is operated to move to the next scan line location of the scan. The steps 101 to 105 are then repeated with the line N becoming the line N−1 for these steps and a new accumulation beginning for a new line N at the new scan line location.

In the prior art, the entire read out process for all of the registered locations 1 to 7500 would have occurred at the 22 MHz speed, this taking an overall duration of 0.34 milliseconds. In comparison, the method described above has a total duration of 0.24 milliseconds. This represents an overall increase in the process speed of about 29% over the prior art.

It will be appreciated that although each of the lines N may have similar target photo-sites and register locations, this is not essential. Indeed the target locations and non-target locations may be controlled independently for each scan line.

In summary therefore the CCD transport register 5 is clocked at a higher frequency when the user is not interested in the output signal of the CCD, and at a lower frequency (which provides high quality data output) when there is interest in the output signal of the CCD.

The selection of the first clock frequency and second clock frequency is dependent upon a number of factors.

The first of these factors is that of the “maximum” transport register frequency. As the clock frequency increases, an increasing amount of the charge from each register location is left behind in the previous register location and is not therefore transferred in the given time allowed by the clock frequency. This is referred to in the art as Total Transfer Efficiency (TTE).

The total transfer efficiency is a measure of the efficiency of transfer of charge from one register location to the next register location.

The second limitation upon the clock frequency is that of the settling time out the output charge amplifier. Sufficient time must be given for the output amplifier to “settle” on each “pixel” of the input register location in order to digitise it accurately. This is known as the “output fall delay time”.

A further limitation is the sample and conversion time of the digitiser in response to the output of the charge amplifier.

When it is desired to obtain a high quality signal, it is necessary to allow for the settling time of the output charge amplifier and the sample and conversion time of the digitiser. For most CCDs when a high dynamic range output is required, each of these have a larger associated time period than the TTE. When there is little interest in the signal, it is then necessary to allow only for the transfer efficiency and as a result it is possible to clock out any register locations of no interest as fast as is possible and therefore as fast as is permitted by the total transfer efficiency.

Although the present example has been described with respect to a single transport register, in other examples two or more transport registers may be used. For example these may take the form of sub-registers such that one sub-register relates to odd numbered photo-sites, that is 1, 3, 5 and so on, whereas the other sub-register relates to even numbered photo-sites. Since each of these sub-registers can be read out at the same time, this improves the overall speed of operation of the apparatus.

Although a linear array of photo-sensors 3 has been described in relation to a CCD, multiple instances of such arrays may be provided, relating to different frequencies of radiation, for example red, green and blue light. Furthermore, although the example has been described with reference to a 1×n CCD array, that is, a linear array of n locations, with n being 7500, it is also possible to use the invention with an m×n array where m may be an integer such as 2, 3 and so on.

In the example mentioned above, a specific second frequency of 44 MHz was used for all non-target locations whereas a first clock frequency of 22 MHz was used for the target locations.

In an alternative example, more than one second clock frequency may be used. This may be advantageous where it is desired to ensure that the target location charges are efficiently transferred along the register until they are positioned for read out. Therefore in this case, a relatively low second clock frequency is used for the non-target locations which are read out prior to any target locations, and a higher second clock frequency is used for those non-target locations where there are no subsequent target locations to be read out. Each of those frequencies are greater than the first clock frequency at which read-out occurs. Since the target locations may be divided into sets which are separated by non-target locations, the lower of the two second clock frequencies may be used for such non-target locations lying between sets of target locations.

A higher second clock frequency can be used for the remaining non-target register locations following read out of all the target locations since, although a small amount of charge may remain in the non-target locations, this can be removed by clocking out a few additional “virtual locations” after the last true non-target location. For example, in a 7500 location register system, the register can be clocked 7510 times (10 virtual locations). Such virtual locations have no charge and since the TTE is greater than 99% even at high clock frequencies only a small number of zero charge virtual locations need to be read out to ensure the register is wiped clean of remaining charge.

In terms of fractions of the maximum clock frequency for the device of the example described earlier, the respective fractions for the non-target (pre-target), target and non-target (post-target) locations might be 0.75:0.5:1, that is a second clock frequency of 33 MHz, a first clock frequency of 22 MHz and a different second clock frequency of 44 MHz respectively. Other ratios are of course envisaged such as 0.1:0.4:1, and so on. Note that such ratios also apply to sub-registers where the clock frequency used can be lower. A two-sub-register system can for example be read out at 11 MHz for the target locations and achieve a similar overall speed.

The present invention can be used in a wide range of applications including scanners, photocopiers, fax machines, microscopes, cameras and position sensing devices.

We claim:

1. A method of operating a radiation monitoring device, the device having a plurality of photo-sites upon which when in use, electrical charges accumulate in response to received radiation, and a transport register comprising a plurality of register locations adapted to receive the accumulated charges from the photo-sites, the method comprising:—
extracting the electrical charges from target register locations corresponding to target photo-sites at a first clock frequency; and
extracting the electrical charges from non-target register locations corresponding to non-target photo-sites at a second clock frequency, the second clock frequency being higher than the first clock frequency.

2. A method according to claim 1, wherein the target photo-sites are photo-sites from which it is desired to monitor image information.

3. A method according to claim 1, wherein the non-target photo-sites are photo-sites from which it is not desired to monitor image information.

4. A method according to claim 1, wherein the extracting of the electrical charges comprises reading out the register locations.

5. A method according to claim 1, wherein each of the photo-sites and register locations are arranged in an array and wherein the charges are extracted from the register in a serial manner.

6. A method according to claim 5, wherein the charges are extracted from one end of the register by shifting the charges between adjacent register locations.

7. A method according to claim 5, wherein, before extraction, the non-target register locations are located at one or each end of the array.

8. A method according to claim 5, wherein, before extraction, the two or more groups of target register locations are located within the register, separated by non-target locations.

9. A method according to claim 5, wherein when any non-target register locations are extracted before any target locations, the said non-target locations are extracted at a second clock frequency adapted to ensure that substantially all of the charges are transferred between adjacent locations.

10. A method according to claim 9, wherein a higher second frequency is used to extract non-target locations after the target locations.

11. A method according to claim 10, further comprising following extraction of all the transport register locations, performing virtual charge extraction from a number of virtual register locations.

12. A method according to claim 1, wherein the second clock frequency is less than 50 MHz.

13. A method according to claim 12, wherein the second clock frequency is substantially 44 MHz.

14. A method according to claim 1, wherein the first clock frequency is less than 25 MHz.

15. A method according to claim 14, wherein the first clock frequency is substantially 22 MHz.

16. A method according to claim 1, wherein the register comprises two or more sub-registers, and wherein the charge is extracted from the locations of each sub-register independently of any other sub-register.

17. A computer program product comprising program code means adapted to perform the method according to claim 1.

18. A computer program product according to claim 17, embodied upon a computer-readable medium.

19. Radiation monitoring apparatus comprising a radiation monitoring device, the device having a plurality of photo-sites upon which, when in use, electrical charges accumulate in response to received radiation, and a transport register comprising a plurality of register locations adapted to receive the accumulated charges from the photo-sites, the system further comprising a controller adapted to perform the steps of:—
extracting the electrical charges from target register locations corresponding to target photo-sites at a first clock frequency; and
extracting the electrical charges from non-target register locations corresponding to non-target photo-sites at a second clock frequency, the second clock frequency being greater than the first clock frequency.

20. Apparatus according to claim 19, wherein the photo-sites are arranged in an array.

21. Apparatus according to claim 20, wherein the array is a linear array.

22. Apparatus according to claim 18, wherein the register comprises two or more sub-registers adapted such that the electrical charges are extracted from the sub-registers independently.

23. Apparatus according to claim 18, wherein the radiation monitoring device is one of a charge coupled device (CCD) CMOS Image Sensor (CIS), Time Domain Integrator (TDI).

24. Apparatus according to claim 18, wherein the apparatus is adapted to monitor one or more of ultra-violet light, visible light, or infra-red light.

25. Apparatus according to claim 18 wherein the controller comprises programmable logic or a microprocessor.
